(19) United States
(12) Patent Application Publication
(10) Pub. No.: US 2021/0210948 A1
(43) Pub. Date: Jul. 8, 2021

(54) PSI Power Source Isolator

(71) Applicant: Cleve Lawrence Molette, San Francisco, CA (US)

(72) Inventor: Cleve Lawrence Molette, San Francisco, CA (US)

(21) Appl. No.: 17/134,662

(22) Filed: Dec. 28, 2020

Related U.S. Application Data
(60) Provisional application No. 62/956,536, filed on Jan. 2, 2020.

(51) Int. Cl. H02H 5/10; H02H 7/26; H01H 51/29

(52) U.S. Cl. CPC H02H 5/10; H01H 51/29; H02H 7/26

(57) ABSTRACT

An electromagnetic device comprising a coil configured electrically in series with and connected directly to a magnetizable switch that said coil controls where when the coil is energized said switch is drawn into contact with an electrical conductor to transmit power from the coil through the switch to said electrical conductor; and a method for instantaneously deenergizing a detached electrical conductor using an electromagnetic gate where operation of said electromagnetic gate and sustention of electrical power flow in said electrical conductor are mutually required; and a machine improvement comprising connecting the output out an electromagnet's circuit into the input of an electromagnetic switch's circuit so that the circuitry of the electromagnet acts in series with the electrical load.

### CROSS-REFERENCE TO RELATED APPLICATIONS

This patent application claims the benefit of U.S. Provisional Ser. No. 62/956,536 filed Jan. 2, 2020. Said related application is incorporated herein by reference.

### FEDERALLY SPONSORED RESEARCH OR DEVELOPMENT

Not Applicable.

### REFERENCE TO SEQUENCE LISTING

Not Applicable.

### BACKGROUND

California wildfires destroyed about 10 million acres in 2017 and about 8.8 million acres in 2018. One of the worst wildfires was the so-called “Camp Fire” with 85 fatalities, about 154,000 acres destroyed, costing almost $17 billion. “Camp Fire” and some other wildfires are caused by power transmission lines that hit the ground fully energized. High winds break the power lines causing them to fall.

Authorities have tried dealing with the problem using what they call Public Safety Power Shutoffs (P.S.P.S.). This is where power lines are shut off for days at a time in places where high winds are expected to possibly break power lines. Public Safety Power Shutoffs may prevent wildfires but have other bad side effects. Probably the worst side effect is that some customers can't operate their life-saving medical equipment while power is shut off.

### BRIEF SUMMARY OF THE INVENTION

These embodiments instantaneously deenergize electrical conductors when those conductors are disconnected from a series circuit. A power line can be deenergized instantaneously after the power line is broken and before the powerline hits the ground to spark a wildfire. This would both prevent wildfires caused by downed power lines as well as eliminate the need to use Public Safety Power Shutoffs.

All authorities can do when high winds down a powerline is repair the line as fast as possible to restore power. However, with the use of one or more of the appropriate embodiments, officials can allow power to remain on throughout high-wind events without fear of broken powerlines causing wildfires.

### BRIEF DESCRIPTION OF THE SEVERAL VIEWS OF THE DRAWING

FIG. 1A shows a plan view of internal parts in accordance with a first embodiment. For clarity, this view and others are shown without a supportive structure.

FIG. 1B shows a sectional elevation view of internal parts inside a supportive structure in accordance with the first embodiment.

FIG. 2A shows a sectional plan view in accordance with a second embodiment using a handle actuated mechanism and spring.

FIG. 2B shows a sectional elevation view in accordance with the second embodiment.

FIG. 3A shows a plan view in accordance with a third embodiment using a sectionalized mechanism, an alternatively configured circuit, and an optional additional power supply.

FIG. 3B show a sectional elevation view in accordance with the third embodiment.

FIG. 4 shows a plan view in accordance with another embodiment using power converters.

FIG. 5 shows a sectional elevation view in accordance with another embodiment using a plurality of devices.

FIG. 6 shows a plan view in accordance with another embodiment using a modified T-handle shaped mechanism.

FIG. 7 shows a plan view in accordance with another embodiment using two devices to control a parallel circuit.

FIG. 8 shows a sectional elevation view of a machine prior to improvement.

FIG. 9 shows the sectional elevation view of the machine of FIG. 8 after improvement.

### DETAILED DESCRIPTION OF THE INVENTION

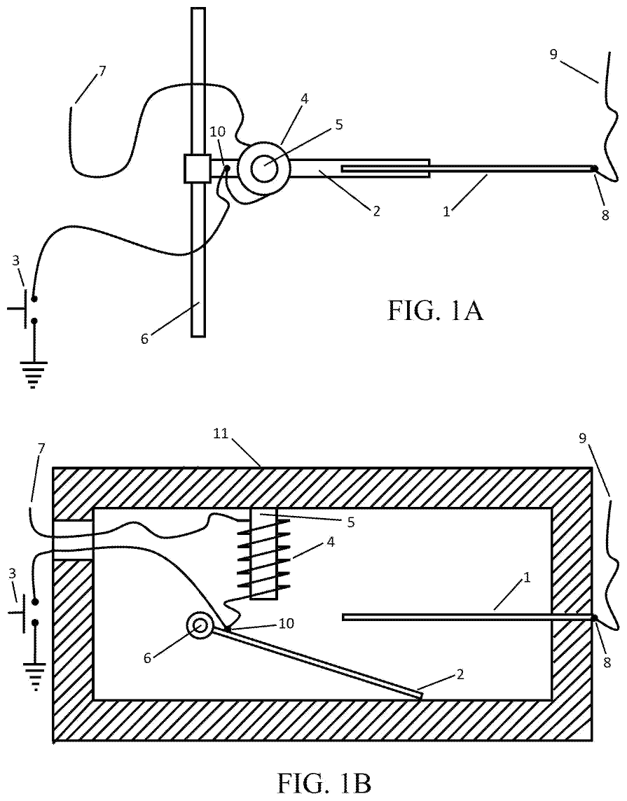

FIG. 1A shows the first embodiment in plan view without a supportive structure and shows a first electrical conductor 1 called a communicator; a second electrical conductor 2 called a collector, that is magnetizable and configured to make and break contact with said first electrical conductor 1; a means to initiate electricity flow 3 called a primer; and a means to generate a magnetic field 4 called a power coil, and is electrically connected to both the second electrical conductor 2 and said means to initiate electricity flow 3.

Communicator 1 is attached at one end to electrical conductor 9 by brazed point 8. Electrical conductor 9 leads to an electrical load. Because electrical conductor 9 leads to an electrical load and is connected to the communicator 1 by brazed point 8, communicator 1 provides an electrical conductor within an electrical circuit.

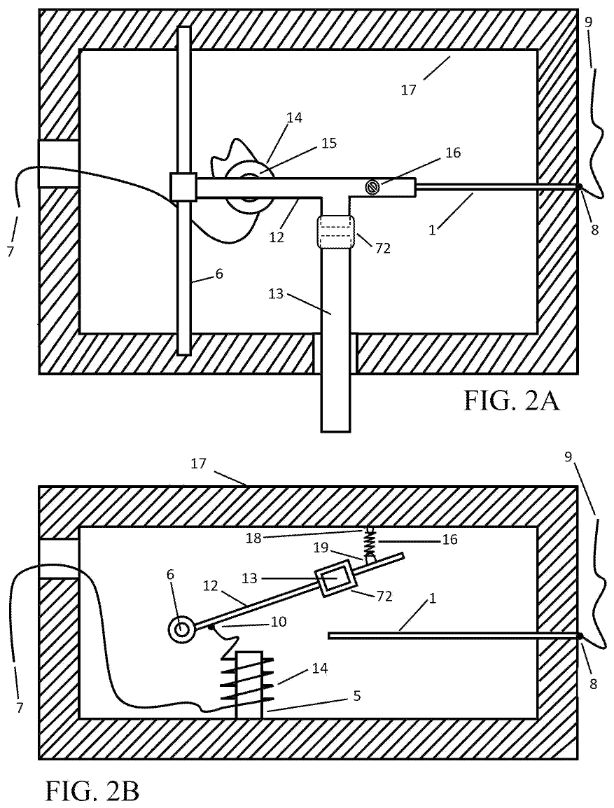

The collector 2 is made of magnetizable material such as iron and is fabricated as one piece with one end having a circle through which axle 6 can be inserted. The collector 2 is centered on axle 6 and attached with an industrial adhesive where the surface of the collector 2 contacts axle 6. The collector 2 is positioned in alignment with the communicator 1. Both ends of the axle 6 are mounted inside a supportive structure in the same manner as shown of axle 6 in housing 17 of FIG. 2A such that the axle 6 can rotate freely.

Because the collector 2 is aligned with the communicator 1 and is attached to the axle 6 which can rotate freely, the collector 2 is configured to make and break contact with said communicator 1. FIG. 1B shows a sectional elevation view of the first embodiment inside the supportive structure 11 called a housing fabricated with non-electrically conductive material.

The power coil 4 is mounted on a core 5 and is positioned in alignment with the collector 2 at a distance such that when the power coil 4 is energized it is configured to act on the collector 2. The combination of the collector 2 and power coil 4 as illustrated provides one embodiment of an electromagnetic gate. One end of the power coil 4 is attached to a power source via an electrical conductor 7. The other end of the power coil 4 is electrically connected in series to the collector 2 and primer 3 at brazed point 10 and by an extension of the power coil's 4 conductor from brazed point 10 to the input point of primer 3. The core 5 is attached to housing 11 with an industrial adhesive where the surface of core 5 contacts housing 11.

OPERATION. Gravity keeps collector 2 at rest on the bottom of housing 11 and disengaged from communicator 1. Power is available from the power source through electrical conductor 7 and power coil 4 to brazed point 10. Power is also available from brazed point 10 to the collector 2 and to the input of primer 3. Primer 3 is pushed to its closed position which causes power to flow through power coil 4.

Power flow through power coil 4 creates an electromagnetic field that draws the collector 2 towards power coil 4 and into contact with communicator 1. Power then also begins to flow from brazed point 10 through collector 2 to communicator 1. Power continues flowing through communicator 1 to electrical conductor 9 and on to the electrical load attached. Primer 3 is then released and returns to its normally open position. Thusly, the electromagnetic gate is configured such that when activated it contacts, energizes, and operates electrically in series with the communicator 1.

While power continues to flow through electrical conductor 9, the electromagnetic field produced by power coil 4 will keep collector 2 engaged with communicator 1. If electrical conductor 9 is broken for any reason at any distance, power flow through the power coil 4 will cease causing the electromagnetic field to collapse releasing collector 2 to disengage from the communicator 1. The communicator 1 and Electrical conductor 9 are thereby deenergized instantaneously being isolated from the power source supplied by electrical conductor 7.

This is a situation whereby a circuit disruption will collapse the magnetic field allowing the collector 2 to disengage from and isolate the communicator 1. In other words, this circuit disruption causes the electromagnetic gate to break contact with and deenergize the communicator 1. Collector 2 will return to rest on the bottom of housing 11. To reiterate, housing 11 is not electrically conductive.

FIG. 2A shows a sectional plan view of a second embodiment with a modified collector 12 that has a non-conductive handle 13 connected with a non-conductive connector 72 using an industrial adhesive on collector 12 and handle 13 surfaces that mate with connector 72. Handle 13 is the means for initiating electricity flow. FIG. 2B more clearly illustrates that the second embodiment also uses a spring 16 attached to the top of the housing 17 and modified collector 12 using two loops 18 and 19. Like Housing 11 of FIG. 1B, housing 17 is not electrically conductive.

This embodiment's power coil 14 connection is modified to terminate on the modified collector 12 at brazed point 10 as there is no push-button type primer as in the first embodiment. OPERATION. Spring 16 keeps collector 12 elevated above and disengaged from communicator 1. Power is available from the power source through electrical conductor 7 and power coil 14 to brazed point 10. Handle 13 is pushed downwards until collector 12 contacts communicator 1. Power begins to flow through power coil 14, collector 12 and communicator 1 into electrical conductor 9. Power flow through power coil 14 creates an electromagnetic field around power coil 14. This electromagnetic field draws the collector 12 towards power coil 14 and keeps collector 12 in contact with communicator 1 after handle 13 is released.

While power continues to flow through electrical conductor 9, the electromagnetic field produced by power coil 14 will keep collector 12 engaged with communicator 1. If electrical conductor 9 is broken for any reason at any distance, power flow will cease and the electromagnetic field will collapse causing Spring 16 to disengage collector 12 from communicator 1 and return it to its elevated position. Electrical conductor 9 is thereby isolated and deenergized instantaneously. To reiterate, housing 17 is not electrically conductive.

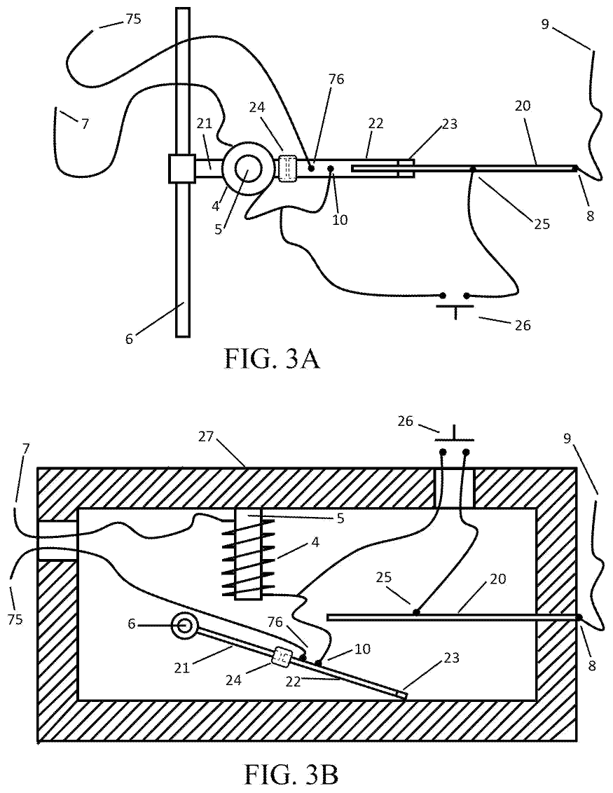

FIG. 3A shows a plan view of a third embodiment using a modified collector with a magnetizable portion 21, a non-magnetizable portion 22 that is electrically conductive, and a non-electrically conductive portion 23. The magnetizable portion 21, and the non-magnetizable portion 22 usually involve dissimilar metals such as in this embodiment with magnetizable iron and non-magnetizable aluminum. A non-metallic connector 24 is used to connect the magnetizable portion 21 and non-magnetizable portion 22 using an industrial adhesive on the surfaces where they contact the connector 24. The non-electrically conductive portion 23 can be connected with an industrial adhesive without a connecter.

This third embodiment also uses a modified primer 26 that is electrically connected to the communicator 20 by a brazed point 25. Please note that the power coil 4 is connected to the non-magnetizable portion 22 of the modified collector because that part is the electrically conductive part. FIG. 3B shows a sectional elevation view of the third embodiment inside the housing 27. OPERATION. Gravity keeps the modified collector portions 21 22 23 at rest on the bottom of housing 27 and disengaged from communicator 20. The housing 27 may or may not be electrically conductive because the modified collector has a non-magnetizable, non-electrically conductive portion 23 that rests against the housing 27. Power is available from the power source through electrical conductor 7 and power coil 4 to brazed point 10 on the non-magnetizable portion 22 of the modified collector that is electrically conductive, and to the input point of primer 26.

Primer 26 is pushed to its closed position which causes power to flow through power coil 4 and Primer 26 into the communicator 20 and on out to the electrical load through electrical conductor 9. Power flow through power coil 4 creates an electromagnetic field around power coil 4. This electromagnetic field draws the collector's magnetizable portion 21 towards power coil 4 until the collector's non-magnetizable portion 22 contacts the communicator 20. Primer 26 is then released and returns to its normally open position. Power then flows only through power coil 4, non-magnetizable portion 22, communicator 20, and out through electrical conductor 9.

While power continues to flow through electrical conductor 9, the electromagnetic field continues drawing magnetizable portion 21 towards power coil 4 keeping non-magnetizable portion 22 engaged with communicator 20. If electrical conductor 9 is broken for any reason at any distance, power flow will cease and the electromagnetic field will collapse releasing collector portion 21 to gravity and disengaging non-magnetizable portion 22 from communicator 20.

Electrical conductor 9 is thereby deenergized and isolated instantaneously. The modified collector will return to rest on the bottom of housing 27. OPTIONAL. FIGS. 3A and 3B show electrical conductor 75 which is a power line or source separate from power coil 4 and is brazed at point 76 to provide a cleaner power source to communicator 20 than is from the power coil 4 at brazed point 10. Its optional on all embodiments. The electromagnetic gate still opens, deenergizes, and isolates communicator 20 if power flow is interrupted.

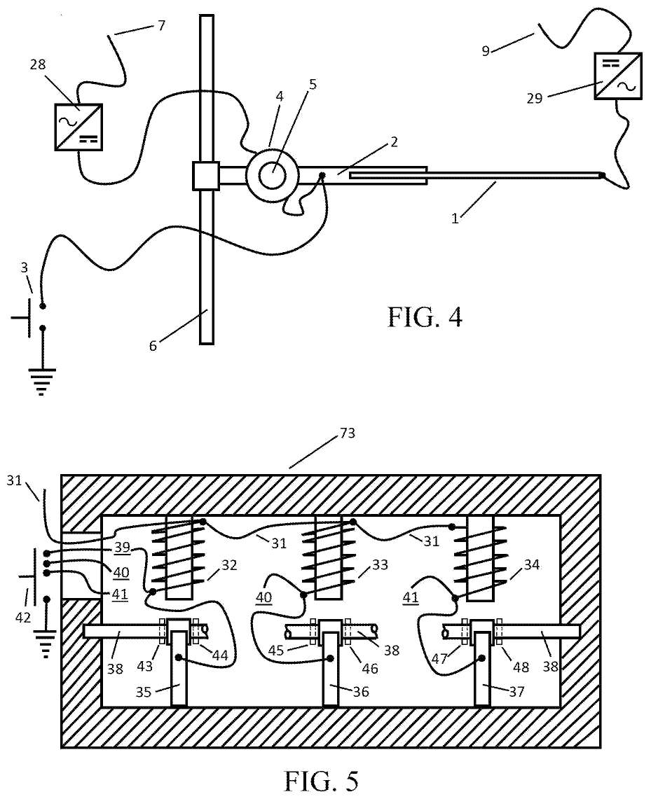

FIG. 4 shows an alternate embodiment utilizing power converters, specifically a rectifier 28 and an inverter 29. OPERATION. It operates in the same manner as the first embodiment except AC power from the power source is converted into DC power by the rectifier 28 before the power enters the power coil 4. DC power suffers less opposition than AC power while traveling through the power coil 4. Also, the DC power is converted back to AC power by the inverter 29 after it exits the communicator 1. AC power has advantages for long-distance transmissions.

FIG. 5 shows a sectional elevation view of an alternate embodiment using multiple power coils 32, 33, 34 and collectors 35, 36, 37. The portion of the housing 30 that is cut away is that portion in which the corresponding communicators would normally be mounted for each power coil 32, 33, 34. The corresponding communicators are not shown for clarity. All connections are made in the same way as in previous embodiments with the following exceptions.

Electrical conductor 31 is from a power source and is connected in parallel to all three power coils 32, 33, 34. The opposite end of power coils 32, 33, 34 are connected to their individual collectors 35, 36, 37 as well as to primer 42 at individual input connections. The electrical conductors between the power coils 32, 33, 34 and the primer 42 are labeled 39, 40, and 41 at both locations to indicate that they are complete, unbroken connections. They are only shown broken for clarity. It cannot be overemphasized that the primer 42 input connection points for electrical conductors 39, 40, 41 must remain electrically isolated from each other when the primer 42 is in its normally open state.

Axle 38 is one continuous piece that is inserted through the circular end of the collectors 35, 36, 37. The collectors 35, 36, 37 are not attached to the axle 38 with industrial adhesive and can rotate independently about the axle 38. The collectors 35, 36, 37 are held in horizontal position by individual dowel pin sets 43 and 44, 45 and 46, and 47 and 48.

OPERATION. This embodiment operates much in the same way as the first embodiment. Gravity keeps collectors 35, 36, 37 at rest on the bottom of housing 73 and disengaged from their individual communicators which are not shown for clarity. Power is available from the power source through electrical conductor 31 and power coils 32, 33, 34 to the brazed points on collectors 35, 36, 37. Power is also available from power coils 32, 33, 34 through electrical conductors 39, 40, 41 to individual, electrically isolated inputs of primer 42. Primer 42 is pushed to its closed position which causes power to flow through power coils 32, 33, 34. Power flow through power coils 32, 33, 34 creates an electromagnetic field around power coils 32, 33, 34.

These electromagnetic fields draw the collectors 35, 36, 37 towards power coils 32, 33, 34 and into contact with their individual communicators which are not shown for clarity. Power then also begins to flow from collectors 35, 36, 37 to their individual communicators. Power continues flowing through the individual communicators to individual electrical conductors and on to the individual electrical loads. Primer 42 is then released and returns to its normally open position. Power then only flows through power coils 32, 33, 34, collectors 35, 36, 37,and their individual communicators and electrical conductors.

While power continues to flow through the individual electrical conductors to each electrical load, the electromagnetic field produced by power coils 32, 33, 34 will keep collectors 35, 36, 37 engaged with their individual communicators. If either electrical conductor attached to an electrical load is broken for any reason at any distance, power flow and the electromagnetic field will collapse for that individual power coil causing the corresponding collector to disengage from its individual communicator. That specific, broken electrical conductor is thereby deenergized and isolated instantaneously. The specific collector will return to rest on the bottom of housing 73. Housing 73 in this embodiment is not electrically conductive.

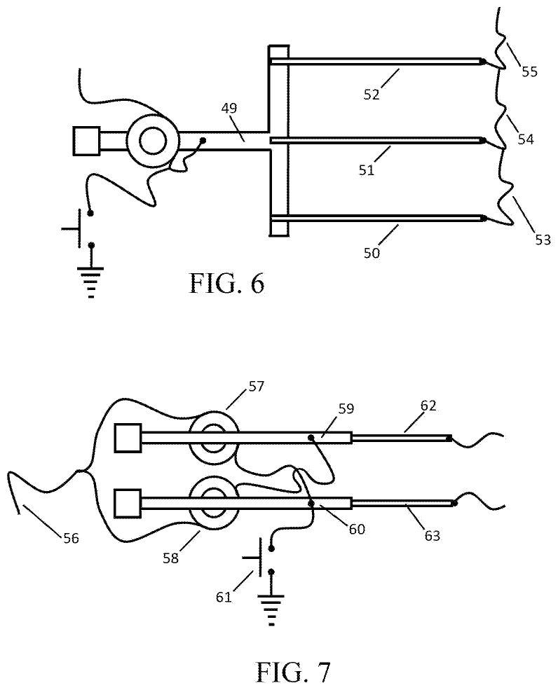

FIG. 6 shows a plan view of an embodiment employing a modified collector 49 in T-handle form used to contact a plurality of communicators 50, 51, 52. Electrical conductor 55 leads to an electrical load, electrical conductor 54 is connected to electrical conductor 55, and electrical conductor 53 is connected to electrical conductor 54.

OPERATION. This embodiment operates like the first embodiment except with a modified, T-handle collector 49 that contacts a plurality of communicators 50, 51, 52 whose electrical conductors 53, 54, 55 connect to form a series circuit out to the electrical load through electrical conductor 55. A disruption between conductor 55 and the electrical load collapses the magnetic field and opens the electromagnetic gate.

FIG. 7 shows a plan view of an alternate embodiment controlling a parallel circuit. Illustrated is an electrical conductor 56 from a power source, two power coils 57 and 58, two collectors 59 and 60, two communicators 62 and 63, and primer 61. The collectors 59 and 60 are configured on an axle like those illustrated in FIG. 5 such that each collector can rotate independently of each other. Each power coil is connected to the opposite collector. Power coil 58 is connected to a brazed point on the opposite collector 59. Power coil 57 is likewise connected to a brazed point on its opposite collector 60. Collector 60 is also connected to the input point on primer 61.

OPERATION. The collectors in this embodiment are configured such that they are elevated above the communicators and power coils like that of FIG. 2B. The embodiment operates such that if the electrical conductor of either communicator breaks, power flow is cut in both circuits.

Power is available from a power source through electrical conductor 56 and through both power coils 57, 58 to a brazed point on the collectors 59, 60 opposite of the power coils 57, 58. Power is also available from the brazed point on collector 60 to the input point on primer 61. Primer 61 is pushed to its closed position initiating power flow through power coil 57. Power flow through power coil 57 creates an electromagnetic field around power coil 57. The electromagnetic field around power coil 57 draws collector 59 into contact with communicator 62. However, this causes power to begin flowing through power coil 58, through collector 59, through communicator 62 and out into the corresponding electrical conductor.

Because power is now flowing through power coil 58, an electromagnetic field is created around power coil 58 which will in kind draw collector 60 into contact communicator 63. At this point, the initial power from the brazed point on collector 60 will flow through both primer 61 and communicator 63 out to its corresponding electrical conductor. The primer 61 is released at that point and power stops flowing through the primer 61 but continues to flow through power coil 57 to collector 60 and communicator 63. Likewise, power continues to flow through power coil 58 to collector 59 and communicator 62.

While power continues to flow out of the communicators 62, 63 to each electrical load, the electromagnetic fields around power coils 57, 58 will keep the collectors 59, 60 in contact with the communicators 62, 63. If either electrical conductor leading from a communicator 62 or 63 breaks, both circuits automatically open as follows.

If the electrical conductor leading from communicator 62 breaks, power ultimately stops flowing through power coil 58. The electromagnetic field around power coil 58 collapes, releases collector 60 and instantaneously deenergizes communicator 63 and its electrical conductor although this electrical conductor did not break. However, with no power flowing through collector 60 to communicator 63, the electromagnetic field around power coil 57 ceases, releases collector 59 and likewise instantaneously deenergizes communicator 62 isolating the broken electrical conductor as well.

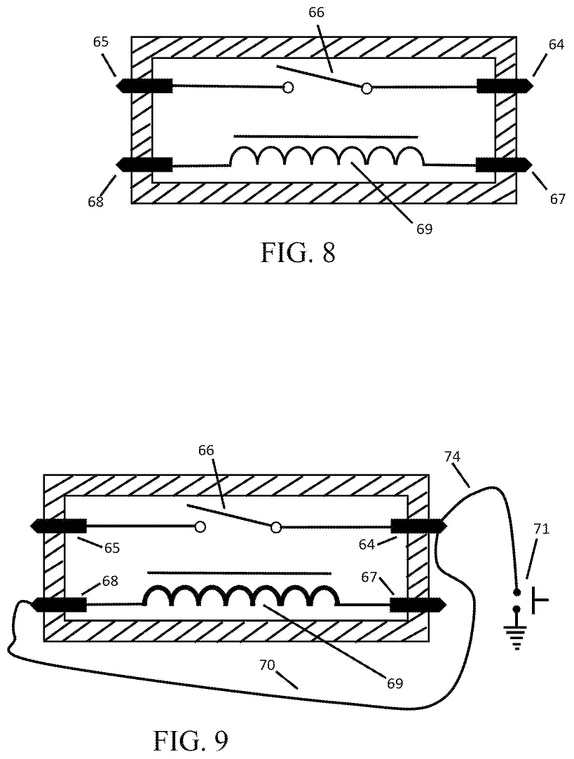

FIG. 8 shows a sectional elevation view of a machine that comprises a first electrical circuit wherein said first electrical circuit contains at minimum an electrical input contact 64, a single-pole single-throw electromagnetic switch 66, and an electrical output contact 65 wherein said machine further comprises a second electrical circuit wherein said second electrical circuit contains at minimum an electrical input contact 67, an electromagnet 69 configured to act upon said single-pole single-throw electromagnetic switch 66, and an electrical output contact 68.

FIG. 9 shows the sectional elevation view of the machine of FIG. 8 wherein the improvement comprises connecting said electrical output contact 68 of the second electrical circuit to said electrical input contact 64 of the first electrical circuit as is illustrated with electrical conductor 70, and connecting the electrical input contact 64 of the first electrical circuit to a means to initiate electricity flow 71 as illustrated by electrical conductor 74.

OPERATION. A power source is connected to input contact 67 making power available through electromagnet 69, electrical conductors 70, 74 up to switch 66 and primer 71. The primer 71 is pushed to its closed position and power flows through the electromagnet 69. Power flow through electromagnet 69 creates an electromagnetic field that acts on and closes electromagnetic switch 66. Power then also flows through the electromagnetic switch 66 to output contact 65 which is connected to an electrical load. Primer 71 is released and returns to its normally open position.

Any disruption of power flow to the electrical load causes the electromagnetic field to collapse, the electromagnetic switch to open, and thereby instantaneously deenergizing any electrical conductor attached to output contact 68 whereby the machine illustrated is improved to perform like an electromagnetic gate. OPTION. Output contact 68 and primer 71 can be connected directly to electromagnetic switch 66.

### CONCLUSION, RAMIFICATIONS, AND SCOPE

Thus, the reader can see that these embodiments allow for instantaneous deenergizing of electrical conductors disconnected from an electrical circuit such as electrical power transmission lines broken by high wind events.

Embodiment construction methods as well as material and component types, sizes, shapes, configurations etc. may vary greatly based on the intended use of the embodiment. It is not practical to list and discuss all possible variations.

The embodiments discussed above should not be construed as limitations on the scope, but rather as exemplifications of several embodiments. Many other variants are possible such as use of primer 3 with the embodiment of FIGS. 3A and 3B, configuring the devices of FIG. 7 to isolate only their corresponding communicators, or even using an electrical solenoid-type magnetic gate where the collector acts as the core of the power coil such that when energized the collector extends out of the power coil to contact the communicator. Accordingly, the scope should be determined by the appended claims and their legal equivalents.

What is claimed is:

1. A machine, comprising:
a. a first electrical conductor,
b. a second electrical conductor that is magnetizable and configured to make and break contact with said first electrical conductor,
c. a means to initiate electricity flow,
d. a means to generate a magnetic field where said means is configured to act on said second electrical conductor and is electrically connected to both the second electrical conductor and said means to initiate electricity flow whereby a circuit disruption will collapse said magnetic field allowing the second electrical conductor to disengage from and isolate the first electrical conductor.

2. A method for instantaneously deenergizing a detached electrical conductor within an electrical circuit, comprising:
a. providing an electrical conductor within an electrical circuit,
b. providing an electromagnetic gate,
c. configuring said electromagnetic gate so that when activated the electromagnetic gate contacts, energizes, and operates electrically in series with said electrical conductor within said electrical circuit whereby circuit disruption causes the electromagnetic gate to break contact with and deenergize the electrical conductor within the electrical circuit.

3. A machine comprising a first electrical circuit wherein said first electrical circuit contains at minimum an electrical input contact, a single-pole single-throw electromagnetic switch, and an electrical output contact wherein said machine further comprises a second electrical circuit wherein said second electrical circuit contains at minimum an electrical input contact, an electromagnet configured to act upon said single-pole single-throw electromagnetic switch, and an electrical output contact wherein the improvement comprises;
a. connecting said electrical output contact of the second electrical circuit to said electrical input contact of the first electrical circuit,
b. connecting the electrical input contact of the first electrical circuit to a means to initiate electricity flow whereby the machine of claim 3 is improved to perform like an electromagnetic gate.
